(19) United States
(12) Patent Application Publication
(10) Pub. No.: US 2011/0297258 A1
(43) Pub. Date: Dec. 8, 2011

(54) HYDRAULIC CONTROL CIRCUIT OF VEHICULAR POWER TRANSMISSION APPARATUS

(76) Inventors: Koichi Tanaka, Okazaki-shi (JP); Atsushi Teshima, Toyota-shi (JP); Yoshihiko Sasaki, Okazaki-shi (JP); Hiroshi Hamaguchi, Nishio-shi (JP)

(21) Appl. No.: 13/115,132

(22) Filed: May 25, 2011

(30) Foreign Application Priority Data
Jun. 7, 2010 (JP) 2010-130250

(51) Int. Cl. F16H 61/28

(52) U.S. Cl. 137/565.11

(57) ABSTRACT

A hydraulic control circuit of a vehicular power transmission apparatus includes: a first passageway providing communication between a pump and a strainer; a second passageway providing communication between the pump and a feeding passageway; a third passageway interconnecting the first passageway and the second passageway; a first check valve being disposed between the strainer and a connecting point between the first passageway and the third passageway, and allowing the oil to flow from a strainer side to a pump side; a second check valve being disposed between the feeding passageway and a connecting point between the second passageway and the third passageway, and allowing the oil to flow from the second passageway to a feeding passageway side; and a third check valve being disposed in the third passageway, and allowing the oil to flow from the first passageway to a second passageway side.

### INCORPORATION BY REFERENCE

The disclosure of Japanese Patent Application No. 2010-130250 filed on Jun. 7, 2010 including the specification, drawings and abstract is incorporated herein by reference in its entirety.

### BACKGROUND OF THE INVENTION

1. Field of the Invention

The invention relates to a hydraulic control circuit of a vehicular power transmission apparatus and, more particularly, to a mechanism that supplies the hydraulic control circuit with an operating oil.

2. Description of the Related Art

An operating oil to be supplied to hydraulic actuators, a lubrication circuit, etc., that are provided in a vehicle automatic transmission and the like is supplied thereto by an oil pump pumping up the operating oil stored in an oil pan and discharging the operating oil into a oil discharge passage that communicates with the hydraulic actuators and the lubrication circuit. Generally, the oil pump is driven by an electric motor or an internal combustion engine provided as a drive source of the vehicle. When the oil pump is driven, the operating oil stored in the oil pan is drawn into an inlet port of the oil pump through an oil strainer and an oil inlet passageway, and is discharged from a discharge port of the oil pump.

For example, in a construction in which an oil pump is driven by an electric motor that functions as a drive source of a vehicle and the electric motor is reversely turned at the time of reverse travel of the vehicle and the like, when the vehicle travels in the reverse direction, the electric motor reversely rotates, and therefore the oil pump reversely rotates. If a disconnecting mechanism is provided between the oil pump and the electric motor, the reverse rotation of the oil pump may be prevented by disconnecting the oil pump from the electric motor if the oil pump is about to reversely rotate. If such a disconnecting mechanism is not provided, the oil pump is allowed to reversely rotate, so that the operating oil on the oil discharge passage side is drawn by the oil pump and the amount of the operating oil in the oil discharge passage becomes insufficient. As a result, air is drawn from the oil discharge passage side, and fills the oil pump and the oil inlet passage. Due to this, when the vehicle is switched to the forward travel, a delay of the rise in the oil pressure occurs. Furthermore, since the amount of oil in the oil pump becomes insufficient, there arises a problem of the oil pump becoming seized up.

To overcome this problem, Japanese Patent Application Publication No. 10-115291 (JP-A-10-115291) describes a technology in which a check valve-equipped one-way oil passage for reverse operation of an oil pump is provided in parallel with the oil pump and an oil inlet passage, and a check valve is also provided between the oil pump and a oil discharge passage. In this technology, when the oil pump reversely turns, the operating oil is caused to circulate in the one-way oil passage provided for the reverse rotation, and the communication between the oil pump and the oil discharge passage side is shut off by the check valve, to prevent drawing in air from the oil discharge passage side into the oil pump.

However, in the lubricating oil pump circuit structure disclosed in the foregoing patent literature, when the oil pump reversely rotates, the operating oil flows (reversely flows) to the oil pan side through the oil inlet passage and the oil strainer. Therefore, there arises a possibility that foreign substances collected by the oil strainer during the normal rotation of the oil pump may diffuse back into the operating oil, and may adhere to mechanical elements, such as bearings, gears, etc., and may adversely affect the mechanical elements.

### SUMMARY OF THE INVENTION

The invention provides a hydraulic control circuit of a vehicular power transmission apparatus which, at the time of reverse rotation of an oil pump, prevents the suction of air from a second oil passageway side and also prevents foreign objects collected in an oil strainer from being diffused into operating oil.

An aspect of the invention relates to a hydraulic control circuit of a vehicular power transmission apparatus. This hydraulic control circuit includes: an oil pump that draws an operating oil through a first port and discharges the operating oil through a second port when forwardly rotated, and that draws the operating oil through the second port and discharges the operating oil through the first port when reversely rotated; a first oil passageway that provides communication between the first port of the oil pump and an oil strainer; a second oil passageway that provides communication between the second port of the oil pump and an oil feeding passageway; a third oil passageway that interconnects the first oil passageway and the second oil passageway and that is in parallel with the oil pump; a first check valve that is disposed in a portion of the first oil passageway between the oil strainer and a connecting point between the first oil passageway and the third oil passageway, and that allows the operating oil to flow from a side of the oil strainer to a side of the oil pump, and that blocks the operating oil from flowing from the side of the oil pump to the side of the oil strainer; a second check valve that is disposed in a portion of the second oil passageway between the oil feeding passageway and a connecting point between the second oil passageway and the third oil passageway, and that allows the operating oil to flow from the second oil passageway to a side of the oil feeding passageway, and that blocks the operating oil from flowing from the oil feeding passageway to a side of the second oil passageway; and a third check valve that is disposed in the third oil passageway, and that allows the operating oil to flow from the first oil passageway to a side of the second oil passageway, and that blocks the operating oil from flowing from the second oil passageway to a side of the first oil passageway.

According to this hydraulic control circuit, when the oil pump forwardly rotates, the operating oil is sucked into the first port of the oil pump from the oil strainer through the first check valve and the first oil passageway, and the operating oil is discharged from the second port into the second oil passageway. Then, the discharged operating oil is supplied from the second oil passageway into the oil feeding passageway through the second check valve. At this time, since the third check valve is closed, the operating oil discharged from the oil pump into the second oil passageway is blocked from returning to the first oil passageway through the third oil passageway, and therefore the operating oil from the second oil passageway is entirely supplied into the oil feeding passageway through the second check valve.

On the other hand, when the oil pump reversely rotates, the operating oil in the second oil passageway is sucked into the oil pump through the second port, and is discharged from the first port of the oil pump into the first oil passageway side. At this time, the first check valve is closed, so that the operating oil discharged into the first oil passageway passes through the third oil passageway and the third check valve, and flows into the second oil passageway. Besides, since the second check valve is closed, there is no flow (reverse flow) of the operating oil from the oil feeding passageway side to the second oil passageway side, and thus the suction of air from the oil feeding passageway side is prevented. Besides, as can be understood from the foregoing description, when the oil pump reversely rotates, the operating oil circulates through the oil pump, the first oil passageway, the third oil passageway and the second oil passageway in that order, and the oil is not discharged to the oil strainer side due to the closure of the first check valve. Therefore, at the time of reverse rotation of the oil pump, the foreign substances collected in the oil strainer during the forward rotation of the oil pump is prevented from diffusing back into the operating oil.

In the hydraulic control circuit, an oil cooler is disposed on a portion of the second oil passageway between the oil pump and the connecting point between the second oil passageway and the third oil passageway.

According to this hydraulic control circuit, since the oil cooler is interposed on the second oil passageway between the oil pump and the connecting point between the second oil passageway and the third oil passageway, that is, in the oil pump side of the connecting point. Therefore, when the oil pump reversely rotates, the operating oil circulates through the oil pump, the first oil passageway, the third oil passageway and the second oil passageway in that order, and the operating oil is cooled by the oil cooler at the time of passage through the second oil passageway. Therefore, the operating oil can be cooled by utilizing the work done by the oil pump, during the reverse rotation of the oil pump as well.

In the hydraulic control circuit, the oil pump may be driven by an electric motor, and the electric motor may be used also as a drive source of the vehicular power transmission apparatus.

According to this hydraulic control circuit, the oil pump is driven by the electric motor, and the electric motor is used also as a drive source of the vehicular power transmission apparatus. Due to this construction, the rotation direction of the electric motor when the motor causes the vehicle to travel in the forward direction and the rotation direction of the electric motor when the motor causes the vehicle to travel in the reverse direction are opposite to each other, and the rotation direction of the oil pump is accordingly switched. In this construction, for example, when the rotation direction of the oil pump is reversed for reverse travel of the vehicle, the suction of air is restrained, and the diffusion of foreign substances is prevented. Thus, a practical lubricating oil producing circuit is provided.

The foregoing aspect of the invention may be applied to electric motor vehicles (EVs) or fuel cell motor vehicles (FC vehicles). In this application, when the electric or FC vehicle forwardly travels, the oil pump is forwardly rotated as the electric motor that functions as a drive source of the vehicle is caused to forwardly rotate. When the vehicle reversely travels, the oil pump is reversely rotated since the electric motor reversely rotates. As described above, in the electric motor vehicles and the fuel cell motor vehicles, the oil pump is rotated in the forward direction or the reverse direction according to the traveling direction of the vehicle, and therefore the flowing direction of the operating oil is accordingly switched. Thus, the expected effect of the invention can be achieved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a drawing conceptually showing a construction of a drive train that is equipped with a vehicular power transmission apparatus according to an embodiment of the invention;

FIG. 2 is a diagram conceptually showing a construction of the drive train viewed from the rear of a vehicle in FIG. 1;

FIG. 3 is a skeleton diagram illustrating a construction of the vehicular power transmission apparatus shown in FIG. 1;

FIG. 4 is a diagram minutely showing an oil passageway construction of a lubricating oil supply circuit shown in FIG. 3; and

FIG. 5 is a diagram showing a modification of the oil passageway construction of the lubricating oil supply circuit shown in FIG. 4.

### DETAILED DESCRIPTION OF EMBODIMENTS

Embodiments of the invention will be described in detail hereinafter with reference to the drawings. In conjunction with the following embodiments, the drawings have been simplified or modified as appropriate, and do not necessarily show accurate measurements or shapes of various portions, or the like.

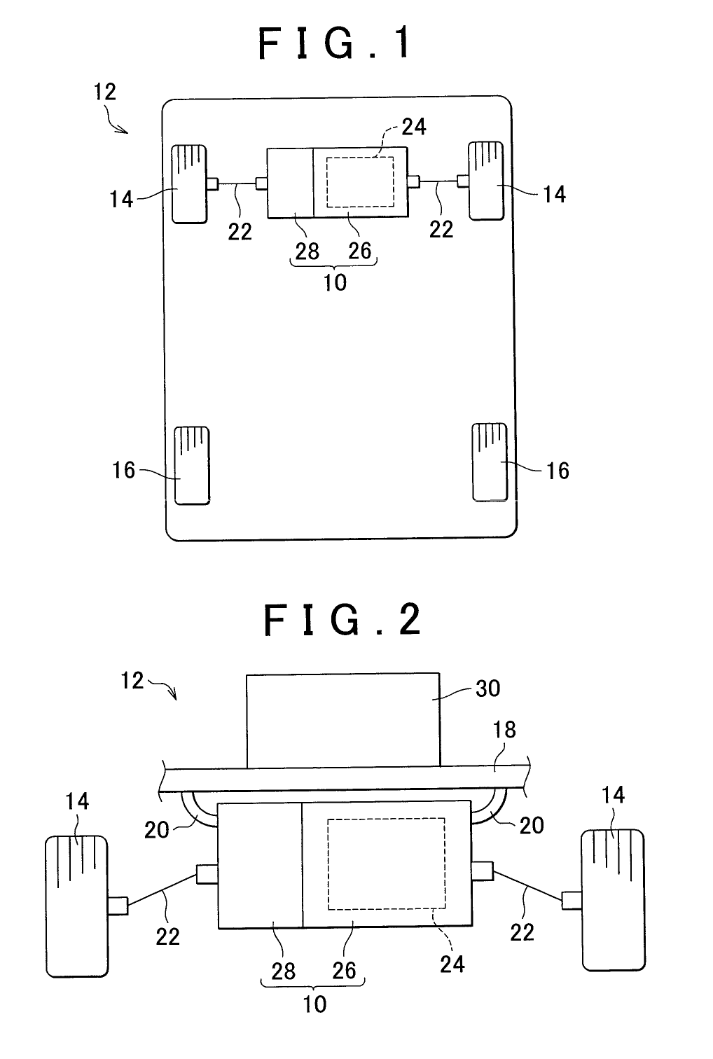

FIG. 1 is a diagram conceptually showing a construction of a drive train of a vehicle 12 that is equipped with a power transmission apparatus 10 in accordance with an embodiment of the invention. FIG. 2 is a diagram conceptually showing the construction of the drive train viewed from the rear of the vehicle 12. In FIG. 1 and FIG. 2, the vehicle 12 includes left and right front wheels 14 and left and right rear wheels 16 that are provided at a front side and a rear side, respectively, of the vehicle 12, and also includes a vehicular power transmission apparatus 10 that is provided at the front side of the vehicle 12 and is fixed to a vehicle body 18 via a mount member 20 as shown in FIG. 2, and that rotationally drives the two front wheels 14 via left and right drive shafts (axles) 22.

The vehicular power transmission apparatus 10 includes: a drive portion 26 that includes an electric motor 24 that functions as a drive source of the vehicle 12 and that is transversely mounted in the vehicle 12; and a transaxle portion 28 that functions as a power transmission apparatus that distributes rotation from the drive portion 26 to a pair of left and right drive shafts 22 while reducing the speed of the rotation. The electric motor 24 is operated by a drive current supplied, for example, from an inverter 30 that is disposed on the vehicle body 18. The vehicle 12 is an FF (front motor, front drive) type electric motor vehicle in which the front wheels 14 as drive wheels are rotationally driven by the electric motor 24 disposed at the front side of the vehicle 12.

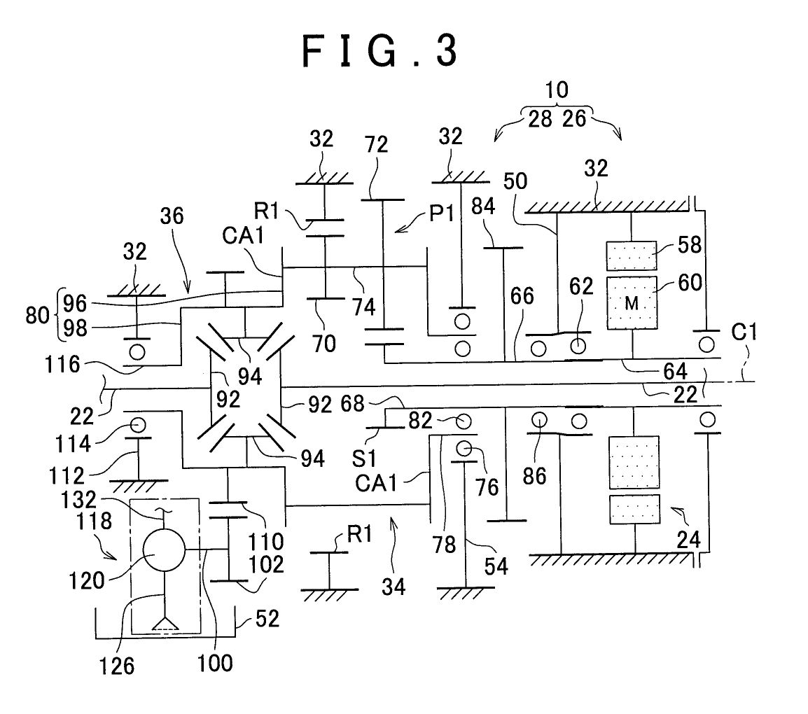

FIG. 3 is a skeleton diagram illustrating the construction of the vehicular power transmission apparatus 10 shown in FIG. 1. In FIG. 3, the vehicular power transmission apparatus 10 includes the electric motor 24, a speed reducer 34 and a differential gear device (differential) 36 that are housed in a transaxle case 32 and that are disposed on a common axis C1. The drive portion 26 mainly includes the electric motor 24. The transaxle portion 28 mainly includes the speed reducer 34 and the differential gar device 36.

The electric motor 24 includes: a stator 58 that is integrally fixed to the transaxle case 32 (hereinafter, sometimes termed the case 32), which is a non-rotating member; a rotor 60 disposed at an inner peripheral side of the stator 58; and a cylindrical output shaft 64 that is rotatably supported via a bearing 62 that is connected to an inner peripheral surface of the rotor 60 and that is fitted to an inner peripheral end of a partition wall 50, or the like. The output shaft 64 is rotationally driven according to the drive current supplied from the inverter 30 to the stator 58. The electric motor 24 constructed in this manner is linked to an input shaft 66 of the speed reducer 34 disposed as a subsequent stage (i.e., disposed at a site to which the drive power from the electric motor 24 is transmitted during the forward (i.e., normal) rotation) to the electric motor 24, and rotationally drives the input shaft 66, for example, by spline fitting.

The speed reducer 34 is a planetary gear type speed reducer that includes: the cylindrical input shaft 66 that is provided on the outer peripheral side of one of the drive shafts 22 and that is unrotatably linked to the output shaft 64 of the electric motor 24, for example, by spline fitting; a sun gear S1 that is unrotatably linked to a shaft end portion 68 of the input shaft 66 that is an opposite side end portion thereof to the electric motor 24, that is, a differential gear device 36-side end portion of the input shaft 66, for example, by spline fitting; stepped pinions P1 each of which has a small-diameter portion 70 and a large-diameter portion 72 that is in mesh with the sun gear S1; a carrier CA1 that supports the stepped pinions P1 via pinion shafts 74 so that the pinions P1 are rotatable about their own axes and are revolvable about the sun gear S1; and a ring gear R1 that is concentric with the sun gear 51 and is unrotatably fixed to the case 32 and that is in mesh with the small-diameter portions 70 of the stepped pinions P1. Incidentally, the carrier CA1 corresponds to one of a plurality of rotating elements that constitute the speed reducer.

The carrier CA 1 has a cylindrical shaft end portion 78 that is supported on an inner peripheral side of an unrotatable support wall 54 via a first bearing 76 so as to be rotatable about the axis C1. Besides, the carrier CA1 is linked to a differential case 80 of the differential gear device 36 disposed as a subsequent stage to the speed reducer 34, and functions as an output member of the speed reducer 34. The speed reducer 34 constructed as described above reduces the speed of the rotation that is input to the input shaft 66 from the electric motor 24, and outputs the reduced-speed rotation to the differential gear device 36.

The input shaft 66 is supported on the inside of the shaft end portion 78 so as to be concentric with the carrier CA1 and be rotatable relatively to the carrier CA1, via a second bearing 82 that overlaps with the first bearing 76 in the radial directions (that is positioned radially inwardly of the first bearing 76). Besides, on the input shaft 66, there is formed a disc-shape parking lock gear 84 that extends in radial directions from the input shaft 66, and that has external teeth on the outer peripheral end. Besides, the input shaft 66 is rotatably supported via a third bearing 86 that is fitted to the inner peripheral end of the partition wall 50.

The differential gear device 36 includes: the two-division differential case 80; a pair of side gears 92 that face each other on the axis C1 of the differential case 80; and three pinions 94 that are disposed between the two side gears 92 and at equal intervals in the circumferential direction, and that each mesh with the two side gears 92. The differential gear device 36 is disposed adjacent to an opposite side of the input shaft 66 to the electric motor 24 in the direction of the axis.

The differential case 80 is made up of a cylindrical first differential case 96 that is disposed at the electric motor 24 side in the direction of the axis, and a cylindrical second differential case 98 that is disposed at an opposite side of the first differential case 96 to the electric motor 24, and that is assembled with the first differential case 96 and is fastened thereto, for example, by bolts (not shown). The differential case 80 is rotatable about the axis C1.

The first differential case 96 is provided integrally with the carrier CA1, and is supported rotatably about the axis C1 via the carrier CA1 and the first bearing 76. The output rotation of the speed reducer 34 is input to the first differential case 96 via the carrier CA1. The first differential case 96 is also an input member of the differential gear device 36. Besides, on the first differential case 96, there is provided a drive gear 110 for rotationally driving a driven gear 102 that is connected to a drive shaft 100 of an oil pump 120 described later. The drive gear 110 is continuously formed in the circumferential direction separately from or integrally with the first differential case 96.

The second differential case 98 is supported rotatably about the axis C1 via a differential side bearing 114 that is fitted to an inner peripheral side of an annular platy bottom wall 112 of the transaxle case 32.

A shaft end portion of the foregoing one of the two drive shaft 22 is linked to an inner peripheral side of the electric motor 24-side side gear 92 of the two side gears 92, for example, by spline fitting, so as to be unrotatable relative to the side gear 92. Besides, a shaft end portion of the other one of the drive shafts 22 is linked to an inner peripheral side of the side gear 92 of the two side gears 92 that is at the side opposite to or remote from the electric motor 24, for example, by spline fitting, so as to be unrotatable relative to the side gear 92. The foregoing one of the two drive shafts 22 is supported rotatably about the axis C1, for example, by the inner peripheral surface of the input shaft 66, and the other drive shaft 22 is supported rotatably about the axis C1 by the inner peripheral surface of a second cylindrical end portion 116 of the second differential case 98.

The differential gear device 36 constructed as described above is rotationally driven by the speed reducer 34 so as to transmit drive force to the two drive shafts 22 that are disposed on the axis C1, while allowing rotational differences between the two drive shafts 22.

As shown in FIG. 3, the vehicular power transmission apparatus 10 includes a lubricating oil producing circuit 118 (shown by a one-dot chain line) for supplying the operating oil (lubricating oil) to various sites that need to be lubricated, for example, a site of mesh between gears, bearings interposed between two members that rotate relative to each other, etc., in the electric motor 24, the speed reducer 34, and the differential gear device 36.

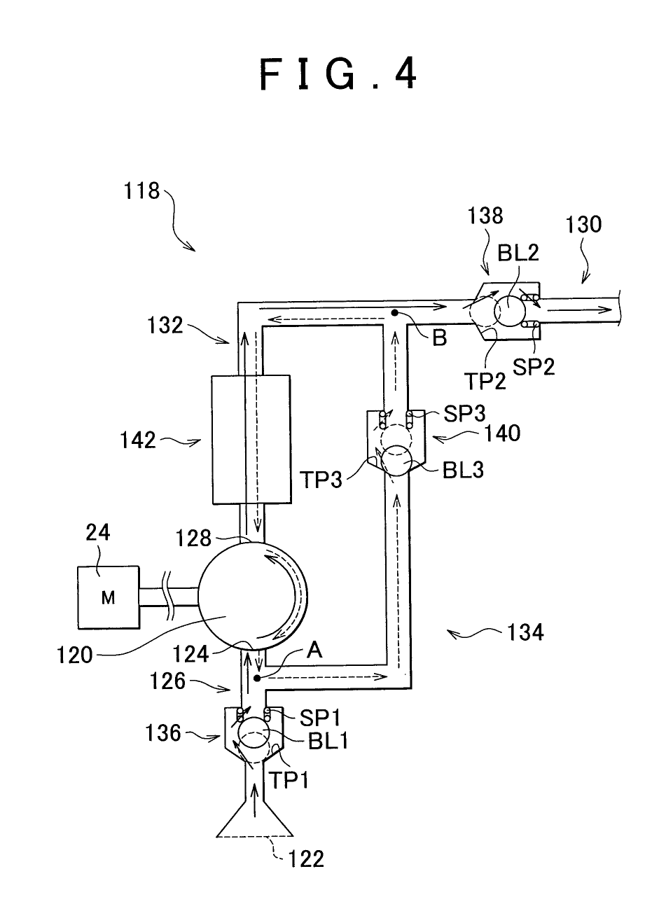

FIG. 4 is a diagram showing details of an oil passageway construction of the lubricating oil producing circuit 118 that constitutes a portion of the hydraulic control circuit according to the invention. The lubricating oil producing circuit 118 includes: the oil pump 120 capable of rotating in the forward and reverse directions; an oil strainer 122 that traps foreign substances in the operating oil (lubricating oil) when the operating oil is sucked up from the oil pan 52; a first oil passageway 126 that provides communication between a first port 124 of the oil pump 120 and the oil strainer 122; an second oil passageway 132 that provides communication between a second port 128 of the oil pump 120 and a lubricating oil passageway 130; a third oil passageway 134 that provides communication between the first oil passageway 126 and the second oil passageway 132; a first check valve 136 that is disposed in an oil strainer 122 side of a connecting point A between the first oil passageway 126 and the third oil passageway 134 (i.e., disposed between the oil strainer 122 and the connecting point A), and that allows the operating oil (i.e., hydraulic fluid) to flow from the oil strainer 122 to the oil pump 120 side but that blocks the operating oil from flowing from the oil pump 120 to the oil strainer 122 side (in the reverse direction); a second check valve 138 that is disposed in a lubricating oil passageway 130 side of a connecting point B between the second oil passageway 132 and the third oil passageway 134 (i.e., disposed between the lubricating oil passageway 130 and the connecting point B), and that allows the operating oil to flow from the second oil passageway 132 to the lubricating oil passageway 130 side but that blocks the operating oil from flowing from the lubricating oil passageway 130 to the second oil passageway 132 side (in the reverse direction); and a third check valve 140 that is disposed on the third oil passageway 134, and that allows the operating oil to flow from the first oil passageway 126 to the second oil passageway 132 side but that blocks the operating oil from flowing from the second oil passageway 132 to the first oil passageway 126 side (in the reverse direction). Besides, an oil cooler 142 is interposed in an oil pump 120 side of the connecting point B between the second oil passageway 132 and the third oil passageway 134 (i.e., interposed between the oil pump 120 and connecting point B). Incidentally, the lubricating oil producing circuit 118 functions as a hydraulic control circuit in the invention, the lubricating oil passageway 130 functions as an oil feeding passageway in the invention, the first check valve 136 functions as a first check valve in the invention, the second check valve 138 functions as a second check valve in the invention, and the third check valve 140 functions as a third check valve in the invention.

The oil pump 120 is constructed of a constant capacity type pump such as internal or external type gear pumps or vane pumps, etc. As shown in FIG. 3, a drive shaft 100 of the oil pump 120 is drivingly connected to the electric motor 24 (i.e., is connected to the electric motor 24 so that power can be transferred between the drive shaft 100 and the electric motor 24), which functions also as a drive source of the vehicular power transmission apparatus 10. Then, as the electric motor 24 is operated in the forward rotation direction (corresponding to the forward traveling direction of the vehicle), the oil pump 120 is driven in the forward rotation direction according to the forward rotation of the drive shaft 100, and therefore draws the operating oil through the first port 124 and discharges it through second port 128 to the second oil passageway 132 side. On the other hand, as the electric motor 24 is operated in the reverse rotation direction (corresponding to the reverse traveling direction of the vehicle), the oil pump 120 is driven in the reverse rotation direction according to the reverse rotation of the drive shaft 100, and therefore draws the operating oil through the second port 128 and discharges it through the first port 124 to the first oil passageway 126 side. Incidentally, the first port 124 functions as a suction port at the time of forward rotation of the oil pump 120, and the second port 128 functions as a discharge port at the time of forward rotation of the oil pump 120.

The first check valve 136, the second check valve 138 and the third check valve 140 (collectively termed the check valves when the three check valves do not need to be distinguished from each other) are mechanical check valves that each control the flow of the operating oil so that the operating oil flows only in one direction. Each of the check valves has a spring (SP1 to SP3) therein. Each check valve is closed as a ball (BL1 to BL3) in contact with the spring (SP1 to SP3) is pressed by the force of the spring (SP1 to SP3) against a conical taper surface (TP1 to TP3) that is formed in the check valve. Each of the check valves has a structure in which if the operating oil flows into the check valve in the permissible flowing direction, the flow of the operating oil pushes up the ball (BL1 to BL3) against the force of the spring (SP1 to SP3), thus opening the check valve. The oil cooler 142 used is, for example, an air-cooled oil cooler or a water-cooled oil cooler. The temperature of the operating oil that passes through the interior of the oil cooler 142 is lowered as appropriate.

The operation of the lubricating oil producing circuit 118 constructed as described above will be described. Firstly, the operation thereof when the oil pump 120 rotates forward is described. Incidentally, the flow of the operating oil during the forward rotation of the oil pump 120 corresponds to arrows drawn with a solid line. Besides, the forward rotation of the oil pump 120 corresponds to the forward travel of the vehicle 12.

When the oil pump 120 is operated in the forward rotation direction (the counterclockwise direction shown by a solid line in FIG. 4) by the electric motor 24, the oil pressure in the first oil passageway 126 becomes negative pressure, so that the operating oil stored in the oil pan 52 shown in FIG. 3 flows into the first oil passageway 126 through the oil strainer 122. At this time, the pressure of the operating oil flowing into the first check valve 136 from the oil strainer 122 side pushes up the ball BL1 against the force of the spring SP1 as shown by a solid line, thus opening the first check valve 136. Therefore, the operating oil drawn up from the oil strainer 122 flows through the first check valve 136, and flows into the oil pump 120 through the first port 124 of the oil pump 120, and is discharged therefrom into the second oil passageway 132 through the second port 128. Incidentally, the first oil passageway 126 functions as a oil inlet passage during forward rotation of the oil pump 120, and the second oil passageway 132 functions as a oil discharge passage during forward rotation of the oil pump 120.

The operating oil discharged into the second oil passageway 132 passes through the oil cooler 142, and flows into the second check valve 138. In the second check valve 138, the pressure of the operating oil flowing in from the second oil passageway 132 side pushes up the ball BL2 against the force of the spring SP2 as shown by a solid line, thus opening the second check valve 138. Due to this, the operating oil from the second oil passageway 132 is supplied into the lubricating oil passageway 130 through the second check valve 138. Incidentally, the lubricating oil passageway 130 is constructed so that the operating oil supplied therein is supplied to various sites that need to be lubricated, such as sites of mesh between gears or bearings of the vehicular power transmission apparatus 10, etc.

Besides, in the third check valve 140, the pressure of the operating oil from the second oil passageway 132 side and the force of the spring SP3 press the ball BL3 against a conical taper surface TP3 that is formed in the third check valve 140 as shown by a solid line, thus closing the third check valve 140. Therefore, the closure of the third check valve 140 blocks the operating oil from flowing from the second oil passageway 132 to the first oil passageway 126 side through the third oil passageway 134. As can be understood from the foregoing description, when the oil pump 120 is rotated in the forward direction, the operating oil drawn up through the oil strainer 122 passes through the first oil passageway 126, and is discharged into the second oil passageway 132, and then is supplied into the lubricating oil passageway 130 through the second check valve 138. Besides, when the oil pump 120 is rotated in the forward direction, the closure of the third check valve 140 blocks the flow of the operating oil in the third oil passageway 134.

Next, the operation performed when the oil pump 120 is reversely rotated will be described. Incidentally, the flow of the operating oil that occurs when the oil pump 120 is reversely rotated corresponds to arrows shown with an interrupted line. Besides, the reverse rotation of the oil pump 120 corresponds to the reverse travel of the vehicle 12.

As the oil pump 120 is operated in the reverse rotation direction (the clockwise direction shown by an interrupted line in HG. 4) by the electric motor, the oil pressure in the second oil passageway 132 becomes a negative pressure, so that the operating oil in the second oil passageway 132 flows into the oil pump 120 through the second port 128 of the oil pump 120, and is discharged therefrom into the first oil passageway 126 through the first port 124. At this time, the oil pressure in the second oil passageway 132 becomes lower than the oil pressure in the lubricating oil passageway 130. Therefore, the operating oil in the lubricating oil passageway 130 tends to flow to the second oil passageway 132 side, but the flow is blocked by the second check valve 138.

In the second check valve 138, the force of the spring SP2 and the oil pressure in the lubricating oil passageway 130 side press the ball BL2 against a conical taper surface TP2 formed in the second check valve 138, as shown by an interrupted line, thus closing the second check valve 138. Therefore, the closure of the second check valve 138 shuts off the communication between the second oil passageway 132 and the lubricating oil passageway 130, so that the flow of the operating oil from the lubricating oil passageway 130 to the second oil passageway 132 side is blocked. Due to this, suction of air produced when the operating oil flows from the lubricating oil passageway 130 side to the second oil passageway 132 side is prevented.

Besides, as the operating oil is discharged from the first port 124 of the oil pump 120 to the first oil passageway 126 side, the oil pressure in the first oil passageway 126 increases. Therefore, in the first check valve 136, the force of the spring SP1 and the oil pressure in the first oil passageway 126 press the ball BL1 against the conical taper surface TP1 that is formed in the first check valve 136, as shown by an interrupted line, thus closing the first check valve 136. Therefore, the operating oil discharged from the first port 124 of the oil pump 120 into the first oil passageway 126 is blocked from flowing to (flowing back to) the oil strainer 122 side. Therefore, since the operating oil discharged from the first port 124 of the oil pump 120 is blocked from flowing to the oil strainer 122 side by the first check valve 136, the foreign substances collected by the oil strainer 122 are prevented from diffusing back into the operating oil.

When the first check valve 136 is closed, the operating oil discharged from the first port 124 of the oil pump 120 into the first oil passageway 126 flows into the third check valve 140 through the third oil passageway 134 as shown by interrupted-line arrows. In the third check valve 140, the oil pressure of the operating oil discharged from the first port 124 of the oil pump 120 pushes up the ball BL3 as shown by an interrupted line against the force of the spring SP3, thus opening the third check valve 140. Therefore, when the oil pump 120 is reversely rotated, the operating oil discharged from the first port 124 of the oil pump 120 into the first oil passageway 126 passes through the third oil passageway 134 (and the third check valve 140) and flows into the second oil passageway 132. After flowing into the second oil passageway 132, the operating oil passes through the oil cooler 142, and is drawn into the oil pump 120 through the second port 128, and is discharged therefrom through the first port 124 into the first oil passageway 126. Specifically, due to the work done by the oil pump 120, the operating oil is circulated through the first oil passageway 126, the third oil passageway 134 and the second passageway 132 in that order. Since the operating oil is circulated as described above, the operating oil does not become insufficient within the oil pump 120 or within the first oil passageway 126, the seizure of the oil pump 120 or the delay of the rise of the oil pressure at the time of switching to the forward travel is improved. Besides, the third oil passageway 134 functions as a bypass oil passageway that leads the operating oil from the first oil passageway 126 into the second oil passageway 132 when the oil pomp 120 reversely rotates.

Besides, since the operating oil circulating in the lubricating oil producing circuit 118 passes through the oil cooler 142, the operating oil is cooled. Specifically, when the oil pump 120 is operated in the reverse rotation direction, the work done by the oil pump 120 brings about the cooling of the operating oil. When the vehicle switches to forward travel and therefore the oil pump 120 switches to forward rotation, the operating oil circulating in the lubricating oil producing circuit 118 and having been cooled by the oil cooler 142 is supplied to the lubricating oil passageway 130, so that various sites that need to be lubricated, such as toothed wheels and bearings of the vehicular power transmission apparatus 10, and the like, are effectively lubricated (cooled).

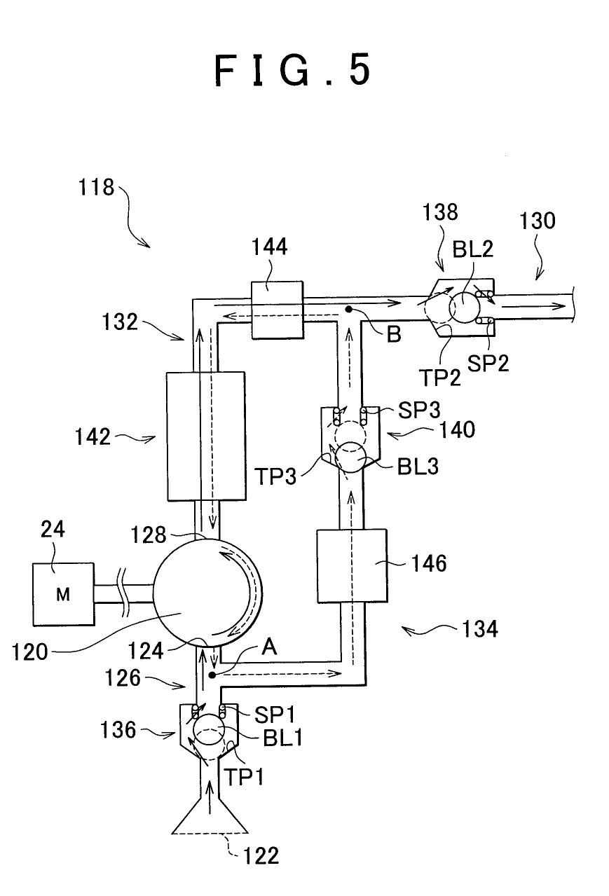

Besides, in order to increase the amount of the operating oil that is cooled during the reverse rotation of the oil pump 120, the second oil passageway 132 and the third oil passageway 134 may be provided with tanks 144 and 146, respectively, as shown in FIG. 5. Due to this arrangement, the amount of the operating oil that circulates in the lubricating oil producing circuit 118 during reverse rotation of the oil pump 120, that is, the amount of the operating oil that is cooled during the reverse rotation, increases by the amount equivalent to the total capacity of the tanks 144 and 146. Therefore, the amount of the cooled operating oil that is supplied into the lubricating oil passageway 130 when the oil pump 120 switches to the forward rotation increases, so that the various sites that need to be lubricated can be more effectively lubricated (cooled).

As described above, according to the embodiment, when the oil pump 120 rotates in the forward direction, the operating oil is drawn from the oil strainer 122 into the first port 124 of the oil pump 120 through the first check valve 136 and the first oil passageway 126, and is discharged from the second port 128 of the oil pump 120 into the second oil passageway 132. Then, the discharged operating oil is supplied from the second oil passageway 132 into the lubricating oil passageway 130 through the second check valve 138. At this time, since the third check valve 140 is closed, the operating oil discharged from the oil pump 120 into the second oil passageway 132 is blocked from returning to the first oil passageway 126 through the third oil passageway 134. Therefore, the operating oil from the second oil passageway 132 is entirely supplied into the lubricating oil passageway 130 through the second check valve 138.

On the other hand, when the oil pump 120 rotates in the reverse direction, the operating oil in the second oil passageway 132 is drawn into the oil pump 120 through the second port 128, and is discharged from the first port 124 of the oil pump 120 to the first oil passageway 126 side. At this time, the first check valve 136 is closed, so that the operating oil discharged from the oil pump 120 into the first oil passageway 126 passes through the third oil passageway 134 and the third check valve 140, and then flows into the second oil passageway 132. Besides, since the second check valve 138 is closed, the operating oil does not flow (does not reversely flow) from the lubricating oil passageway 130 side to the second oil passageway 132 side. Thus, the suction of air from the lubricating oil passageway 130 side is prevented. Besides, when the oil pump 120 reversely rotates, the operating oil circulates through the oil pump 120, the first oil passageway 126, the third oil passageway 134 and the second oil passageway 132 in that order, and the operating oil is not discharged to the oil strainer 122 side because the first check valve 136 is closed. Therefore, when the oil pump 120 reversely rotates, the foreign substances collected in the oil strainer 122 during the forward rotation of the oil pump 120 is prevented from diffusing back into the operating oil.

Besides, according to this embodiment, since the oil cooler 142 is disposed in the oil pump 120 side of the connecting point B between the second oil passageway 132 and the third oil passageway 134, the operating oil is cooled by the oil cooler 142 when the oil pump 120 reversely rotates and the operating oil passes through the second oil passageway 132 in the sequence of circulation through the oil pump 120, the first oil passageway 126, the third oil passageway 134 and the second oil passageway 132. Therefore, the operating oil can be cooled by using the work done by the oil pump 120 during the reverse rotation of the oil pump 120 as well.

Besides, according to the embodiment, the oil pump 120 is driven by the electric motor 24, and the electric motor 24 is also used as a drive source of the vehicular power transmission apparatus 10. In this construction, the direction of rotation of the electric motor 24 when the vehicle 12 is caused to travel forward and the direction of rotation thereof when the vehicle 12 is caused to reversely travel are opposite to each other, and therefore the rotation direction of the oil pump 120 is accordingly switched. Due to this construction, for example, when the rotation direction of the oil pump 120 is reversed for reverse travel of the vehicle, the suction of air is restrained, and the diffusion of foreign substances is prevented. Thus, the foregoing construction provides a practical lubricating oil producing circuit 118.

While the embodiments of the invention have been described in detail above with reference to the drawings, the invention is also applicable in other embodiments.

For example, although in the foregoing embodiments, the oil pump 120 is driven by the electric motor 24 and the suction side and the discharge side of the oil pump 120 are interchanged according to the rotation direction of the electric motor, the invention is not limited to the construction in which the oil pump is driven by an electric motor. For example, in a configuration in which an oil pump is linked to an output shaft of a transmission that switches between the forward and reverse travel modes so that drive power can be transmitted between the oil pump and the transmission, the rotation direction of the oil pump changes as the transmission switches between a forward travel gear and a reverse travel gear. The invention is applicable to these configurations as well. That is, the invention is applicable to any configuration as long as the configuration is such that the rotation direction of the oil pump switches according to the state of travel of the vehicle.

Besides, although in the foregoing embodiments, the oil discharged into the second oil passageway 132 is supplied into the lubricating oil passageway 130 so as to lubricate mechanical elements, the invention is not limited to the lubricating oil passageway 130. For example, the invention may also be applied to an oil pressure supply circuit that generates a basic pressure for hydraulic actuators that are provided in an automatic transmission, or the like.

Besides, in the foregoing embodiments, the operating oil discharged from the oil pump 120 is supplied to the lubricating oil passageway 130 during the forward travel of the vehicle, and the operating oil is circulated in the lubricating oil producing circuit 118 during the reverse travel of the vehicle. However, the invention is not necessarily limited to the configuration in which the operating oil is supplied to the lubricating oil passageway 130 during the forward travel, but may also be applied to a configuration in which the operating oil is supplied in to the lubricating oil passageway 130 during the reverse travel. Specifically, the invention is also applicable to a construction in which the operating oil is circulated in the lubricating oil producing circuit 118 during the forward travel of the vehicle, and the operating oil is supplied into the lubricating oil passageway 130 during the reverse travel of the vehicle.

Besides, the internal constructions (linkage relations) of the vehicular power transmission apparatus 10 in the above embodiments are mere examples, and may be modified as appropriate without causing contradiction.

The above embodiments are mere illustrative examples, and the invention can be implemented with various modifications and changes based on the knowledge of a person having ordinary skill in the art.

What is claimed is:

1. A hydraulic control circuit of a vehicular power transmission apparatus, comprising:
an oil pump that draws an operating oil through a first port and discharges the operating oil through a second port when forwardly rotated, and that draws the operating oil through the second port and discharges the operating oil through the first port when reversely rotated;
a first oil passageway that provides communication between the first port of the oil pump and an oil strainer;
a second oil passageway that provides communication between the second port of the oil pump and an oil feeding passageway;
a third oil passageway that interconnects the first oil passageway and the second oil passageway and that is in parallel with the oil pump;
a first check valve that is disposed in a portion of the first oil passageway between the oil strainer and a connecting point between the first oil passageway and the third oil passageway, and that allows the operating oil to flow from a side of the oil strainer to a side of the oil pump, and that blocks the operating oil from flowing from the side of the oil pump to the side of the oil strainer;
a second check valve that is disposed in a portion of the second oil passageway between the oil feeding passageway and a connecting point between the second oil passageway and the third oil passageway, and that allows the operating oil to flow from the second oil passageway to a side of the oil feeding passageway, and that blocks the operating oil from flowing from the oil feeding passageway to a side of the second oil passageway; and
a third check valve that is disposed in the third oil passageway, and that allows the operating oil to flow from the first oil passageway to a side of the second oil passageway, and that blocks the operating oil from flowing from the second oil passageway to a side of the first oil passageway.

2. The hydraulic control circuit according to claim 1, wherein
an oil cooler is disposed on a portion of the second oil passageway between the oil pump and the connecting point between the second oil passageway and the third oil passageway.

3. The hydraulic control circuit according to claim 1, wherein
direction of rotation of the oil pump is switched according to state of travel of the vehicle.

4. The hydraulic control circuit according to claim 3, wherein
the oil pump is driven by an electric motor, and the electric motor is used also as a drive source of the vehicular power transmission apparatus.

5. The hydraulic control circuit according to claim 3, wherein
the oil pump is linked to an output shaft of a transmission capable of switching between a forward travel and a reverse travel so that power is transferrable at least from the output shaft to the oil pump.
